(19) United States
(12) Patent Application Publication
(10) Pub. No.: US 2022/0050027 A1
(43) Pub. Date: Feb. 17, 2022

(54) LABORATORY (LAB) GRINDERS CAPABLE OF SIMULTANEOUSLY GRINDING MULTIPLE SAMPLES WITHOUT CROSS-CONTAMINATION AND METHOD OF GRINDING LAB SAMPLES

(71) Applicant: TOI VAN VO, HO CHI MINH (VN)

(72) Inventor: TOI VAN VO, HO CHI MINH (VN)

(73) Assignee: VIETNAM NATIONAL UNIVERSITY HO CHI MINH CITY, HO CHI MINH (VN)

(21) Appl. No.: 17/398,744

(22) Filed: Aug. 10, 2021

(30) Foreign Application Priority Data
Aug. 11, 2020 (VN) 1-2020-04607

(51) Int. Cl. G01N 1/28; B02C 19/08; B02C 21/00; B02C 25/00

(52) U.S. Cl. CPC G01N 1/286; B02C 19/08; G01N 2001/2866; B02C 25/00; B02C 21/00

(57) ABSTRACT

A cross-contamination free and efficient laboratory sample grinder is disclosed which includes: a first housing unit having a plurality of pestle ejecting pins arranged in a fixed position, a second housing unit containing a planetary gear system connected to operate an array of mortars and pestles, and a third housing unit containing a single motor and controllers; when the first housing unit is in lock position with the second housing unit, and a third housing unit containing a single motor and controllers. The first housing unit, the second housing unit, and the third housing unit are geometrically configured and dimensioned so that when they are stacked on top of one another they are in lock position and consequently the array of pestle ejecting pins are lined up with the plurality of pestle ejecting pins.

### CLAIM OF PRIORITY

This application is a continuation application under 35 U.S.C. § 120 of Application No. 1-2020-04607, filed on Aug. 11, 2020, in the Republic Socialist of Vietnam, entitled, “Thi\hat{é}t Bi Nghi\hat{è}n Nhi\hat{è}u M\hat{ã}u Mô Cùng Lúc Mà Không Lây Nhi\hat{\tilde{e}}m và Phuong Pháp Nghi\hat{è}n Nhi\hat{è}u M\hat{ã}u Mô Cùng Lúc Bà̆ng Thi\hat{é}t Bi Này”. The patent application identified above is incorporated here by reference in its entirety.

### FIELD OF THE INVENTION

The present invention relates generally to the field of laboratory testing devices. More specifically, the present invention relates to a laboratory grinding machine.

### BACKGROUND ART

Clinical and diagnostic tests in laboratories are useful in screening, diagnosis, prognosis, therapeutic monitoring, follow-up tests, and other qualitative and quantitative applications. These tests require grinding or homogenizing specimens—including tissue, cells, and other samples. Conventionally, mechanical instruments such as mortars and pestles are used to grind or homogenize the specimens. First, specimens are deposited into a mortar (receptacle), a buffer solution is added therein. Then, the tissue sample is manually grinded with a pestle. This conventional method requires significant labor manual and only one sample can be done at a time. These mortars and pestles are made of non-metal materials to be cost effective and convenient, and to avoid contamination by nano-sized metal particles.

In the U.S. Pat. No. 5,829,696 entitled “Sealed Grinding and Homogenizing Apparatus” to DeStefano et al. (hereinafter referred to as “the DeStefano patent”, an apparatus for grinding specimens comprising a container, a grinder, and a grinding head 40 is disclosed. The grinding head 40 is designed to prevent the specimens from escaping and thus causing cross-contamination. In the DeStefano patent, the replaceable grinding head 40 seals the top side of grinding tube 22 so that the specimens cannot splash out escaping and contaminating the surrounding laboratory environment and/or neighboring grinding tubes 22. However, the DeStefano patent does not disclose simultaneously grinding or homogenizing multiple grinding tubes 22 at the same time. Thus, DeStefano's grinding apparatus is still performed manually and inefficient. Furthermore, the DeStefano's grinding apparatus does not prevent cross contamination when some of the debris on the grinding tube 22 escape as the grinding tubes 22 are pulled out after the homogenizing process is complete. In addition, contamination may be caused by aerosolization that carries droplets of specimens to the neighboring containers. In case of grinding infectious specimens such as samples containing the COVID-19 or SARS-CoV-2 virus for biological testing purposes, aerosolization could propagate the spread of this dangerous virus.

In another U.S. Patent Application number US-2007/0262181, entitled, “Device and Method for Grinding Biological Samples” by Cazrnek (hereinafter referred to as “Caznek's application”, an electrical sample grinding device is disclosed. The Caznek's grinding apparatus as shown in FIG. 1 includes a ball bearing 4 mounted on a shaft 2, and a drive mechanism 6 (a motor 6, FIG. 8 in the Caznek's application).The ball bearing 4 end of shaft 2 is inserted in an open end of a sample vial 8 having a conical or concave-shaped interior bottom wall 10 opposite the open end. However, the Caznek's grinding apparatus does prevent cross contamination when some of the debris on the shaft 2 escape as shaft 2 are pulled out of the sample vial 8. Furthermore, the Caznek's application fails to teach grinding multiple samples using multiple vials 8 at the same time. Please see Caznek's FIG. 9. Therefore, the Caznek's grinding apparatus is still inefficient.

In a more recent U.S. Pat. No. 9,556,410, entitled, “Homogenizer and Storage Cooler” to Jindo et al. (hereinafter referred to as “the Jindo's patent”), an electrical homogenizer and storage cooler is disclosed which includes: a main body, a storage cooler. The storage cooler is configured to cool a tissue sample in a sample container. Even though Jindo's patent teaches homogenizing a multiple of samples using electrical power (see Jindo' FIG. 10, step S1), the cross contamination between samples in adjacent vials 5 (see FIG. 6) cannot be prevented as the blenders 31 are withdrawn. Furthermore, the Jindo's homogenizer 1 is complicated, expensive, and cannot grind a large number of samples with its horizontal arrangement as shown in FIG. 9.

In an international patent application No. WO 02/48679, entitled, “Device for Deintegrating Biological Samples” by Gianmarco Roggero (hereinafter referred to as “the Roggero's application”), a disintegrating device is disclosed which includes a container 2, a shaft 26 mounted for rotation inside the container 2 with a blade 28 on the end inside container 2. The shafts 26 are coupled together by ball coupling means 30 (metal balls), 34 (frusto-conical cavity). Even though the Roggero's device can grind multiple samples at the same time, it requires four separate motors 52 (“deconstituting devices are aligned with the four electric motors 52 (FIG. 2c)”, the Roggero's application, page 7), thus energy inefficient. Furthermore, the Roggero's device cannot prevent cross contamination of samples as engagement means 40 and shafts 54 are withdrawn from container 2. Additionally, the Roggero's device is arranged horizontally as shown in FIG. 3a and FIG. 3b, occupying a large lab bench's spaces with only four samples being deconstituted at a time.

Thus, what is needed is a grinding and homogenizing apparatus designed to operate on multiple samples at the same time without using separate electrical motors. What is needed is a grinding and homogenizing apparatus designed to avoid cross contamination to the specimens neighboring containers or receptacles as the pestles are pulled out after the grinding operation is completed. Additionally, what is needed is a grinding and homogenizing apparatus that is geometrically arranged to hold the most number of sample containers without occupying a large surface area of the laboratory bench. What is needed is a grinding and homogenizing apparatus that can avoid the aerosolization phenomena that could propagate droplets of samples throughout the laboratory environment.

Finally, what is needed is a arinding and homogenizing apparatus that is cost-effective, easy to handle, and energy efficient.

The grinding and homogenizing apparatus of the present invention meets the above needs.

### SUMMARY OF THE INVENTION

The present invention has been made in view of the aforementioned circumstances, and therefore, an object of the present invention is to provide a novel laboratory grinder designed to prevent cross contamination among samples.

An object of the present invention is to provide laboratory sample grinder which includes: a first housing unit having a plurality of pestle ejecting pins arranged in a fixed position, a second housing unit containing a planetary gear system connected to operate an array of mortars and pestles, and a third housing unit containing a single motor and controllers; when the first housing unit is in lock position with the second housing unit, and a third housing unit containing a single motor and controllers. The first housing unit, the second housing unit, and the third housing unit are geometrically configured and dimensioned so that when they are stacked on top of one another they are in lock position and consequently the array of pestle ejecting pins are lined up with the plurality of pestle ejecting pins.

An object of the present invention is to provide a method of grinding/milling/homogenizing a multiple laboratory samples without cross-contamination including: (a) lining up an array of mortars containing laboratory samples with an array of pestle ejecting pins designed to press an array of pestles to fall completely into an array of mortars; (b) maintaining the array of pestles, the array of mortars, and the array of pestle ejecting pins lined up using a pair of male lock key and female lock key; and (c) starting grinding a plurality of samples using a single motor and a planetary gear system.

Another object of the present invention is to provide a laboratory grinder that is energy efficient; that is a lab sample grinder that grindslmills/homogenizes multiple samples without using more than one electrical motor.

Another object of the present invention is to achieve cross-contamination free lab sample grinding/milling/homogenizing apparatus using a simple system of pestle ejecting pins.

The above objectives are achieved by providing a method of manufacturing an efficient and cross-contamination free laboratory sample grinder which comprises: (a) preparing ejecting means for ejecting an array of pestles into an array of mortars; (b) calculating distances between the pestles in the array of pestles, and those between mortars in the array of mortars; and (c) preparing a locking means so that when the grinder is in the lock state the array of pestles, the array of mortars, and the ejecting means are lined up.

These and other advantages of the present invention will no doubt become obvious to those of ordinary skill in the art after having read the following detailed description of the preferred embodiments, which are illustrated in the various drawing Figures.

### BRIEF DESCRIPTION OF THE DRAWINGS

The accompanying drawings, which are incorporated in and form a part of this specification, illustrate embodiments of the invention and, together with the description, serve to explain the principles of the invention.

FIG. 1 is a 3D diagram illustrating a cylindrical structure of the laboratory grinding/milling/homogenizing apparatus (“lab sample grinder”) in accordance with an exemplary embodiment of the present invention;

FIG. 2A-2B is a 3D diagram showing the internal and external structures and different components of the first housing unit including an array of pestles ejecting pins in accordance with an exemplary embodiment of the present invention;

FIG. 3A is a 3D diagram illustrating the three housing units of the lab sample grinder in an open state in accordance with an exemplary embodiment of the present invention;

FIG. 3B is a 3D blow-up diagram of the interior space of the third housing unit showing the distal end of the pestle rod in accordance with an exemplary exemplary embodiment of the present invention;

FIG. 4A is a 3D diagram showing the internal components contained the second housing unit of the lab sample grinder in accordance with an exemplary embodiment of the present invention;

FIG. 4B is a top-down view of a unit of a first insertion disc illustrating the manner pestles are inserted, lined up, and held firmly inside each pestle hole in accordance with an exemplary embodiment of the present invention;

FIG. 5 is a 3D diagram illustrating a geometrical structure of the second housing unit of the lab sample grinder in accordance with an exemplary embodiment of the present invention;

FIG. 6 is a 3D diagram illustrating a geometrical structure of the third housing unit of the lab sample grinder in accordance with an exemplary embodiment of the present invention;

FIG. 7 is a 3D cutaway diagram illustrating the mating state between the second housing unit and the third housing unit the specimen mortars (containers) of the lab sample grinder in accordance with an exemplary embodiment of the present invention;

FIG. 8 is a 3D cutaway diagram illustrating the relative positions of the second housing unit, the third housing unit, and the pestles and mortars when they are in the disconnection state in accordance with an exemplary embodiment of the present invention;

FIG. 9 is 2D diagram illustrating the complete structure and components inside the first housing unit, the second housing unit, and the third housing unit of the lab sample grinder in accordance with an exemplary embodiment of the present invention;

FIG. 10 is a top-down 2D diagram illustrating the structure of the planetary gear system used in the lab sample grinder in accordance with an exemplary embodiment of the present invention;

FIG. 11 is schematic diagram of the electronic components of the controller unit of the lab sample grinder in accordance with an exemplary embodiment of the present invention; and

FIG. 12 is a flowchart of a method of grinding multiple lab specimens without cross-contamination using only one electrical motor in accordance with an exemplary embodiment of the present invention.

### DETAILED DESCRIPTION OF THE INVENTION

Reference will now be made in detail to the preferred embodiments of the invention, examples of which are illustrated in the accompanying drawings. While the invention will be described in conjunction with the preferred embodiments, it will be understood that they are not intended to limit the invention to these embodiments. On the contrary, the invention is intended to cover alternatives, modifications and equivalents, which may be included within the spirit and scope of the invention as defined by the appended claims. Furthermore, in the following detailed description of the present invention, numerous specific details are set forth in order to provide a thorough understanding of the present invention. However, it will be obvious to one of ordinary skill in the art that the present invention may be practiced without these specific details. In other instances, well-known methods, procedures, components, and circuits have not been described in detail so as not to unnecessarily obscure aspects of the present invention.

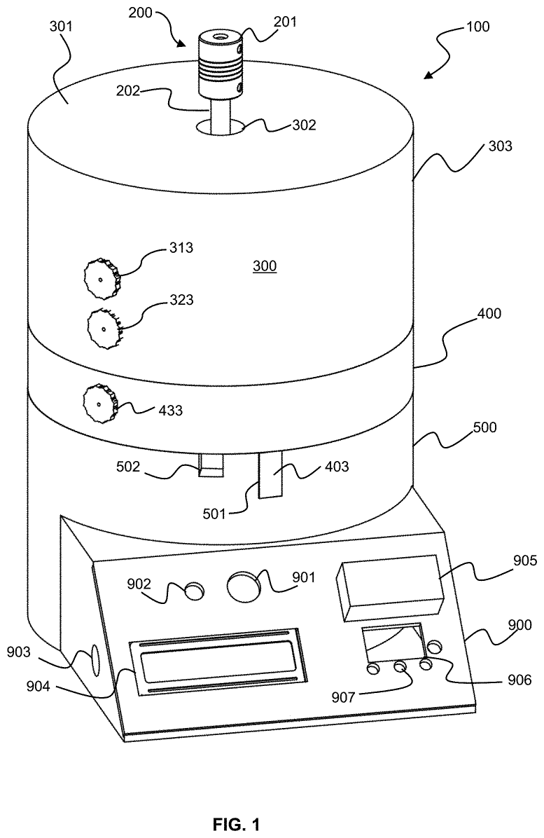

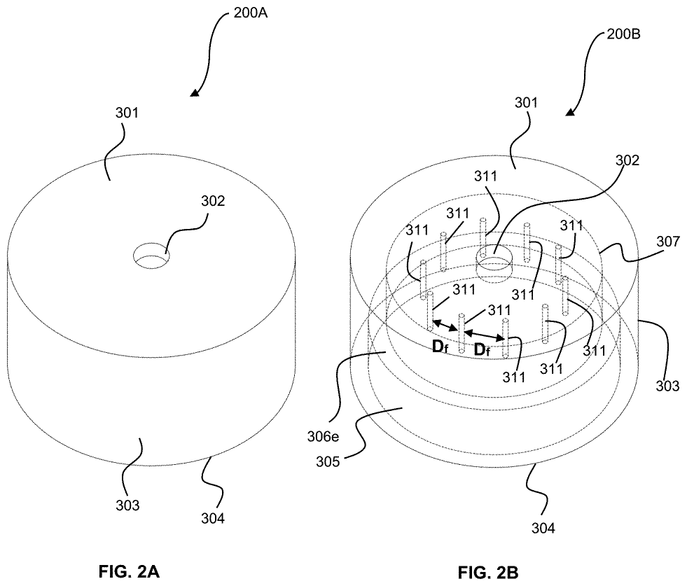

Now referring to FIG. 1, a 3D diagram of a cylindrical shaped laboratory sample/grinding/homogenizing device (lab sample grinder) 100 of an exemplary embodiment of the present invention is illustrated. Lab sample grinder 100 includes—from the bottom up—a controller unit 900, a third housing unit 500, a second housing unit 400, a first housing unit 300, and a main shaft 200. As shown, main shaft 200 includes a handle 201 releasably connected to an axle 202 which functions as the main actuator of the grinding/milling/homogenizing operations. The complete structure and functions of main shaft 200 will be shown and disclosed in FIG. 2. First housing unit 300 has a cylindrical structure with a thru hole 302 formed at the center of its top side 301. A pair of first position fixing screws 313-314 and a pair of second position fixing screws 323-324 are conveniently located on the lateral side of first housing unit 300. First housing unit 300 also has an alignment lock key 403 projecting downward from the bottom side. Alignment lock key 403 plays a very important role many advantageous embodiments of the present invention. Because of alignment lock key 403, different important internal components of lab sample grinder 100 are configured to precisely lined up, ensuring proper operations of lab sample grinder 100 and preventing cross contamination to between samples. The working principle of alignment lock key 403 will be described hereinbelow. In some other embodiments, second housing unit 400 also has a third pair of position fixing screws 433-434. Third housing unit 500 has an alignment lock receiver 501 and a post-op unlock receiver 502. During grinding/milling/homogenizing operations, alignment lock receiver 501 is mated with alignment lock key 403, lining up different components inside of lab sample grinder 100. When finished, post-op unlock receiver 502 is mated with alignment lock key 403, readying the mortars of samples to be removed without cross contamination. In many embodiments of the present invention, both alignment lock key 403 and alignment lock receiver 501 have rectangular shape with equal length. However, post-op unlock receiver 502 also has a rectangular shape but is shorter in length, making the post-operation removing and cleaning up more convenient.

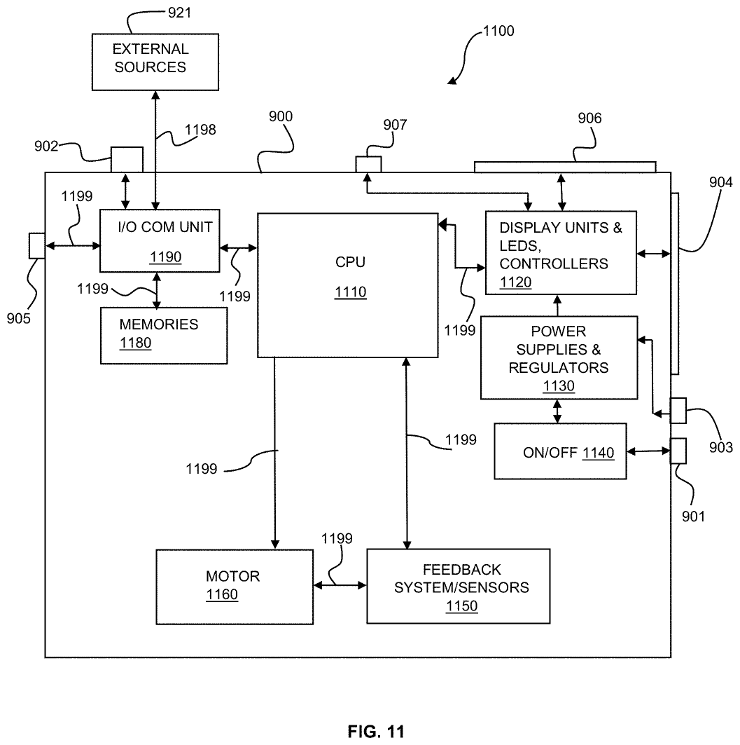

Continuing with FIG. 1, controller unit 900 is mechanically secured to third housing unit 500. On the front façade, controller unit 900 includes an ON/OFF button 901, a speed dial knob 902, a display unit 904, an operation time setting unit 905, a digital running time display unit 906, a warning light emitting diode (LED) 907. On the lateral side, an electrical connector 903 provides electrical power supplies to controller unit 900. In some embodiments of the present invention, electrical connector 903 is a Universal Serial Bus (USB). In some other embodiments, electrical connector 903 is a typical male-female IEC 320 connectors. In some other embodiments, electrical connector 903 is male DC power jack plugs of various sizes from 0.6 mm to 2.1 mm. In some aspects of the present invention, controller unit 900 also has an input/output communication device (shown in FIG. 11) that enables lab sample grinder 100 to communicate with external devices (shown in FIG. 11).

Now referring to FIG. 2A, a 3D diagram of an external structure 200A of first housing unit 300 is illustrated. Externally, first housing unit 300 is uniformly cylindrical in shape with top side 301, lateral side 302, and a first foot base 304. Thru hole 302 is formed at the center of top side 301. In FIG. 2B, a 3D diagram of an interior structure 200B of first housing unit 300 is presented which includes a first bottom interior segment 305 is concentrically laid below a first top interior segment 307 with different girth (surface) diameters, creating a first interior collar 306e. On the ceiling inside first top interior segment 307, an array of pestle ejecting pins 311 is arranged in a circular formation with predetermined equidistance D_{f} between them. In some exemplary embodiment of the present invention, first housing unit 300 has a surface diameter of 160 millimeters (mm) and a height of 85 mm. Each pestle ejecting pin 311 has a diameter of 2 mm and a height of 11 mm. One end of each pestle ejecting pin 311 is fixedly connected to the ceiling inside first top interior segment 307 and the other end is pointing vertically downward, designed to make contact with the base of each pestle rod 801.

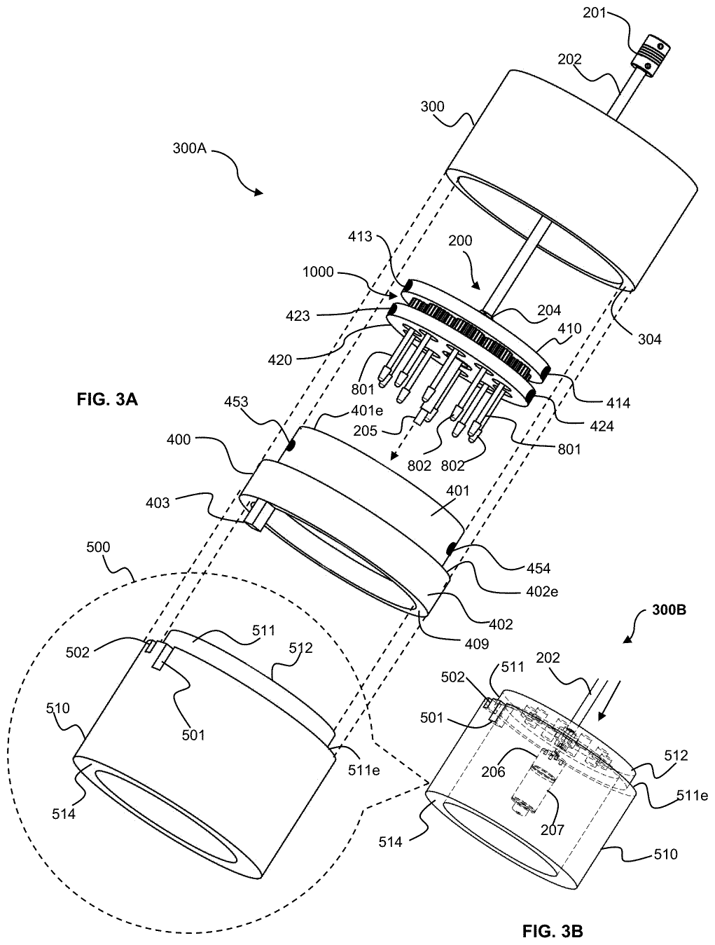

Next referring to FIG. 3A, a 3D diagram 300A of the top three housing units of the lab sample grinder in an open state in accordance with an embodiment of the present invention is illustrated. Second housing unit 400 has two concentric cylindrical segments with different girth (surface) diameters. A second bottom segment 402 and a second top segment 401. Second bottom segment 402 has a larger girth diameter than that of a second top segment 401, thus forming a second collar 402e. Second bottom segment 402 has the same surface diameter as that of first bottom interior segment 305 so that the exterior surfaces of two housing units 300 and 400 are flushed, creating a taller cylindrical shape. Second bottom segment 402 has a surface diameter of 160 mm. However, second top segment 401 has a slightly smaller surface diameter than that of first top interior segment 307. The surface diameter of second top segment 401 is designed to be 140 mm so that second top segment 401 can slide pass and be inserted inside first top interior segment 307. Second top segment 401 has a fifth and a sixth screw holes 453 and 454 for locking with a third pair of position holding screws 433 and 434 respectively. Similarly, third housing unit 500 also has a cylindrical shape with a third bottom segment 510 concentrically aligned with a third top segment 511. Third bottom segment 510 has the same surface diameter as those of second bottom segment 402 and first bottom interior segment 305, which is 160 mm, so that they form a higher and externally smooth cylindrical shape when assembled together. As alluded above, the bottom side of second bottom segment 402 has lock alignment key 403 that is either mated with either alignment lock receiver 501 or post-op unlock receiver 502, depending on the operating stage of lab sample grinder 100.

Continuing with FIG. 3A, a first insertion disc 410 and a second insertion disc 420 are removably held to axle 202 and at the same time sandwich a planetary gear system 1000 therebetween. On the opposite sides of second insertion disc 420, there are a second pair of screw holes 423-424 for connecting with second pair of position fixing screws 433-434. When first housing unit 300, second housing unit 400, and third housing unit 500 are stacked together, they are automatically in the line-up state. It is noted that the terms “lined up”, “lined up state”, or “lock state”, or “in a lock state” when used within the present Disclosure mean that first pair of position locking screws 313-314 can be tightly connected to first pair screw holes 413-414 without causing any deformation in geometrical shape, damages, and position misalignment to first insertion disc 410; second pair of position locking screws 323-314 can be tightly connected to first pair screw holes 413-424 without causing any deformation in geometrical shape, damages, and position misalignment to second insertion disc 420; and third pair of position locking screws 433-434 can be tightly connected to third pair screw holes 453-454 without causing any deformation in geometrical shape, damages, and position misalignment to first housing unit 300 and second top segment 401. Any devices, means, systems, or apparatuses that cause these “lined up”, “lined up state”, or “lock state”, or “in a lock state” are within the teachings of the present disclosure.

In FIG. 3B, a blow-up diagram 300B of an interior space of third housing unit 500 is presented to show the distal end of main shaft 200. The distal end of main shaft 200 is a tip 205 for removably connecting to a motor connector 206 which, in turn, fixedly connected to a motor 207. Motor connector 206 functions to prevent main shaft 200 from freely moving pass second housing unit 400. Motor connector 206 uses means such as détente ball lock mechanism, friction lock, or threaded fastener. During grinding/milling/homogenizing operations, main shaft 200 remains locked to motor 207 of controller unit 900. In the détente ball lock mechanism, handle 201 is pressed down to push or withdraw a pair of steel balls into or from the locking positions. In the friction lock mechanism, tip 205 is shaped in a rectangular geometry which is snugly inserted into holding connector 206 which has the same rectangular receiving end. In the threaded fastener, handle 201 is twisted to screw on or screw off axle 202 into or out of holding connector 206 respectively. Other locking mechanisms which can connect or remove axle 202 to holding connector 206 are also within the scope of the present invention. It is appreciated by a person of ordinary skills in the art that connections between tip 205 of axle 202 and holding connector 206 described herewith may be by any other suitable means such as nails, screws, bolts, connectors, pins, staples, dowels or the likes.

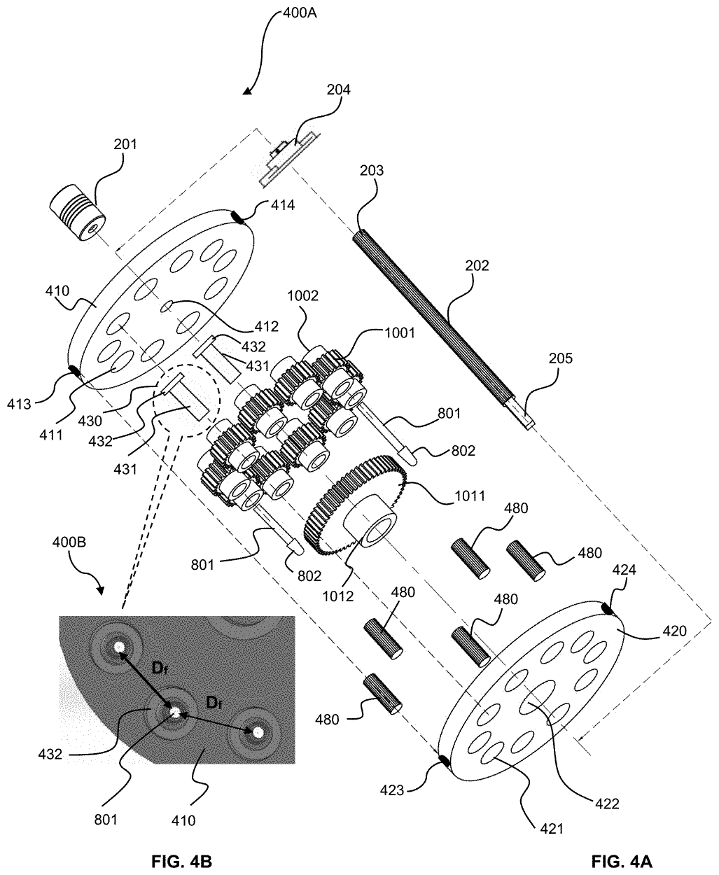

Referring next to FIG. 4A, a 3D diagram 400A showing various internal components contained in second housing unit 400 of lab sample grinder 100 in accordance with an embodiment of the present invention is illustrated. The description of main shaft 200 is now continued: Main shaft 200 includes a proximate end 203, axle 202, and distal end which is tip 205 having smaller surface area and different geometrical shape than that of axle 202. Proximate end 203 is connected to handle 201 and a squeeze disc lock 204. Handle 201 is made of steel or aluminum with a diameter of 20 mm and a height of 25 mm. Axle 202 is made of steel and has a diameter of 8 mm with a length of 100 mm. Next, near the perimeter edge of first insertion disc 410 locates a first circular array of pestle insertion holes 411 arranged around a first shaft insertion hole 412. First insertion disc 410 is made of aluminum with a diameter of 120 millimeters (mm) and thickness of 10 mm. Each of first array of pestle insertion holes 411 has a diameter of 16 mm while first shaft insertion hole 412 has a larger diameter of 82 mm. On the opposite sides of first insertion disc 410, first pair of screw holes 413 and 414 designed to line up and connect to first pair of position fixing screws 313-314 respectively. Similarly, near the perimeter edge of second insertion disc 420 includes a second circular array of pestle insertion holes 421 arranged around a second shaft insertion hole 422. Second insertion disc 420 is made of aluminum with a diameter of 120 millimeters (mm) and thickness of 10 mm. Each of second array of pestle insertion holes 412 has a diameter of 16 mm while second shaft insertion hole 422 has a larger diameter of 25.5 mm. On the opposite sides of second insertion disc 420, second pair of screw holes 423 and 424 designed to connect to second pair of position fixing screws 323-324 respectively.

Continuing with the discussion of FIG. 4A, planetary gear system 1000 including driven gear 1001 arranged into a circular trajectory which is in teeth communication with a driving gear 1011 at the center. Driving gear 1011 is designed to have 60 teeth, diameter of 60 mm, and a thickness of 5 mm. A central bearing 1012 firmly connects driving gear 1011 with axle 202 so that when axle 202 is rotated by motor 207 driving gear 1011 also rotates. Consequently, array of driven gears 1001 rotates at a speed equal to the speed of driving gear 1011 multiplied by the ratio of number of teeth of driving gear 1011 over that of driven gear 1001. Each driven gear 1001 is also supported by a bearing 1002 and has a diameter of 20 mm and thickness 5 mm with 20 teeth. With this exemplary embodiment, if the speed of motor 207 is 1231 rpm for an operation time of 15 minutes, the speed of each driven gear 1001 is 3,693 rpm (1231×60/20) for 15 minutes. All bearings 1011 and central bearing 1012 are hollow tubes where pestles 810 are inserted therethrough. Spacers 480 are screwed in to secure first insertion disc 410 and second insertion disc 420 in parallel to each other—which means that first array of pestle insertion holes 411 is lined up with second array of pestle insertion holes 422 and first central shaft insertion hole 412 is lined up with second central shaft insertion hole 422. Additionally, spacers 480 are purported to hold the distance between two discs 410 and 420 constant. As such, planetary gear system 1000 is secured inside. Each spacer 480 has a surface diameter of 5 mm and height 12 mm. Within the meaning of the present invention, the “in position”, “in place” , “in lock”, or “lock in” means that every components described above are lined up precisely so that lab sample grinder 100 operates properly as it is intended to do without causing damages, misalignments, deformations thereto.

In FIG. 4B, an exploded top down view 400B of a unit of first insertion disc 410 is illustrated. From top-down view 400B, mounting sleeves 430 are used to mount and firmly hold pestles 810 inside bearing 1002. In many different embodiments of the present inventions, each mounting sleeve 430 includes a tubular body 431 and a flange 432, all are hollow and precisely measured so that tubular body 431 fits snugly inside bearings 1002. As alluded above, the centers of two adjacent pestle rods 801 have the distance of D_{f} which is precisely the same as that between two adjacent pestle ejecting pins 311. First, mounting sleeves 430 are inserted through first pestle insertion holes 411 with tubular bodies 431 pointing vertically downward toward bearing 1002. Pestle rods 801 are pressed into second pestle insertion holes 421 into tubular body 431 until the bases of pestle rods 801 emerge in flush with the surface of first insertion disc 410 as shown in diagram 400B.

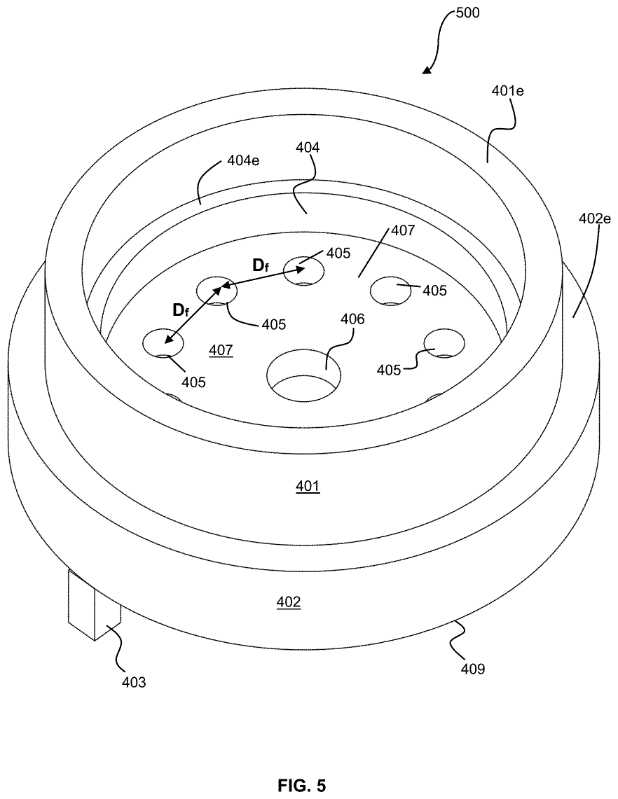

Next referring to FIG. 5, a 3D diagram 500 representing the geometrical shape and structure of second housing unit 400 of lab sample grinder 100 in accordance with an embodiment of the present invention is illustrated. When disassembled to an individual component, second housing unit 400 is a hollow cylindrical structure which includes second top segment 401 laid concentrically on top of second bottom segment 402, thus forming second collar 402e. Second top segment 401 is itself a hollow cylinder with a surface diameter of 140 mm and a height of 35 mm. The top rim surface of second top segment 401 is a second top rim 401e. A bottom divider 407 includes a first array of mortar insertion holes 405 arranged around a third shaft insertion hole 406. Each mortar insertion hole 405 has a diameter of 11 mm. On the bottom side of second bottom segment 402, alignment lock key 403 is attached and pointing vertically downward. The distances between the centers of any two adjacent mortar holes 405 are D_{f} so that first array of mortar insertion holes 405 lines up precisely with first array of pestle insertion holes 411 and second array of pestle insertion hole 421 when alignment lock key 403 is mated with alignment lock receiver 501. As such, first shaft insertion hole 412, second shaft insertion hole 422, and third shaft insertion hole 406 are also lined up precisely. Inside second top segment 401, a second interior segment 404 having a smaller surface diameter is formed to create an interior edge 404e. When lined up, first insertion disc 410, planetary gear system 1000, and second insertion disc 420 rest on interior edge 404e and are stored completely inside the interior space of second top segment 401.

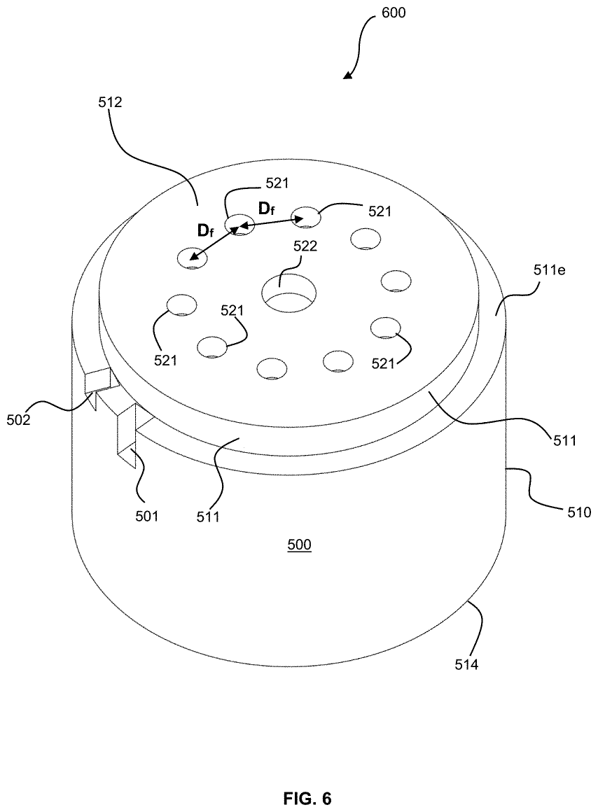

Referring now to FIG. 6, a 3D diagram 600 representing a geometrical structure and measurements of the third housing unit 500 of lab sample grinder 100 in accordance with an embodiment of the present invention is illustrated. When disassembled to an individual component, third housing unit 500 is a hollow cylindrical structure which includes third top segment 511 laid concentrically on top of third bottom segment 510. Third bottom segment 510 has a surface (girth) diameter of 160 mm and a height of 30 mm. Third top segment 511 functions as a fourth insertion disc whose a top surface 512 has a surface (girth) diameter of 140 mm. Third top segment 511 is the structured substantially similar to first insertion disc 410 and second insertion disc 420. A third collar 511e is formed around the base of third top segment 511. On third top surface 512, a second array of mortar insertion holes 521 is arranged a fourth shaft insertion hole 522 and in the same fashion, dimension, and measurements as first array of mortar insertion holes 405 around so that they are all lined up precisely when alignment lock key 403 is mated with alignment lock receiver 501. Right next to the base of third top segment 511, alignment lock receiver 501 and post-op unlock receiver 502 are edged onto third collar 511e of third bottom segment 510. The bottom side of third bottom segment 510 is a third foot base 514.

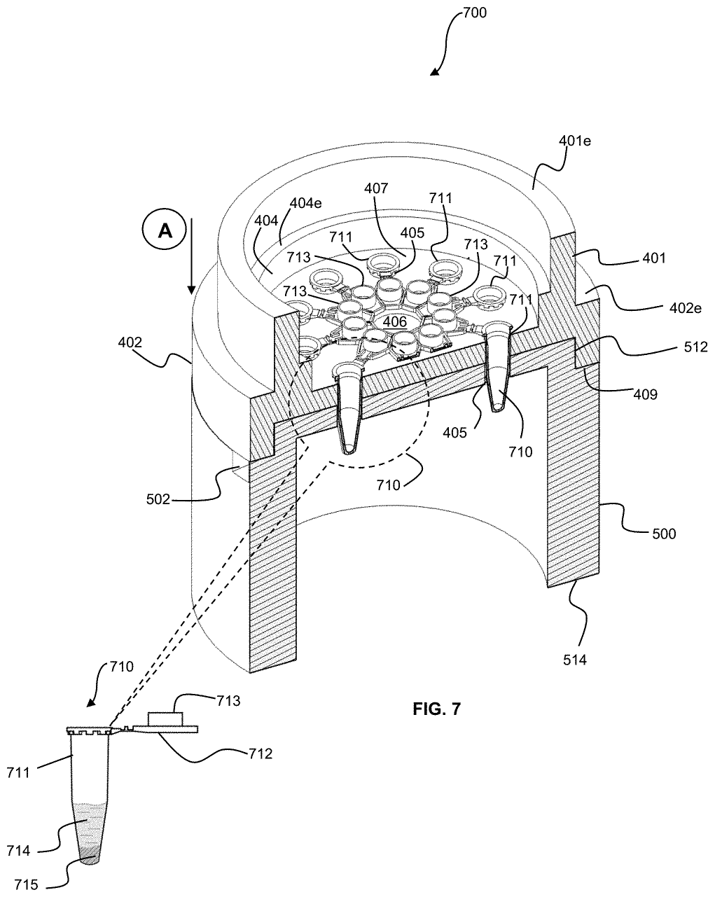

In FIG. 7, a 3D cutaway diagram 700 illustrating the line-up state between second housing unit 400 and third housing unit 500 of lab sample grinder 100 in accordance with an embodiment of the present invention is illustrated. In diagram 700, a vertical cut away is performed right after alignment lock key 501 creating a coronal plane elucidating the manner array of vials 710 are inserted into first array of mortar insertion holes 405. In various embodiments of the present invention, a lock state or line-up state is achieved by an A motion. A motion is a stacking or vertically pressing down action. When A motion is performed, second housing unit 400 is stacked on top of third housing unit 500 as alignment lock key 403 is mated with alignment lock receiver 501. As such, the following line-up occurs: a second foot base 409 of second bottom segment 402 is rested on a third collar 511e of third top segment 511. Afterwards, an array of vials 710 is inserted into first array of mortar insertion whole 405. In one exemplary embodiment of the present invention, vial 710 is a test tube 10 mL non-spilled specimen container which includes a hinged lid 712 connected to a mortar 711. Hinged lid 712 includes a seal cap 713 hinged to mortar 711, it hermetically seals off laboratory specimens including solvent 714 and sample 715 inside. In a non-limiting example, each array of vials 710 is manufactured under UNSPSC code 410000000 and has a part number of NTK-TTSR. Each vial in an array of vails 710 may be manufactured according to other industrial standards such as from Corning® or Pyrex®. It is noted that other types of vials, lab sample containers, sample collectors, test kits and their respective dimensions and standards are within the scope of the present invention.

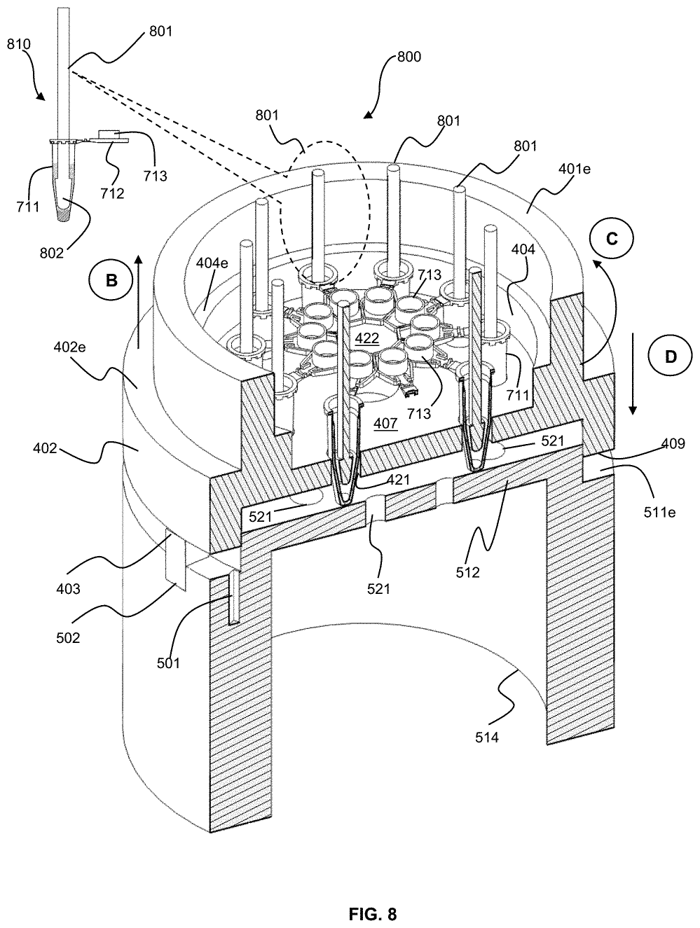

Referring next to FIG. 8, a 3D cutaway diagram 800 illustrating the relative positions of second housing unit 400, third housing unit 500, and array of vials 710 when they are disassembled in accordance with an embodiment of the present invention is illustrated. Each of array of pestles 810 has a pestle rod 801 and a bulging header 802 with larger girth diameter. After the grinding/milling/homogenizing of specimens 715 is completed, alignment lock key 403 is lifted off completely from alignment lock receiver 501 in accordance to a motion indicated by an alphabet B, simultaneously removing array of vials 710 from second array of mortar insertion holes 521. Then second housing unit 400 is slightly rotated either clockwise or counterclockwise to create a misalignment state or a non-lineup state, indicated by a motion C. Accordingly, the bases of array of vials 710 is rested completely on the top surface of third top segment 511. Finally, alignment lock key 403 is mated with post-op unlock receiver 502. Since the length of alignment lock key 403 is greater than that of post-op unlock receiver 502 by an amount carefully designed beforehand, the bases of array of vials 710 are now pushed upward by the surface of third top segment 511, losing the array of mortars 711 from the grip of second array of mortar insertion holes 521. This push up to eject motion is indicated by a motion D.

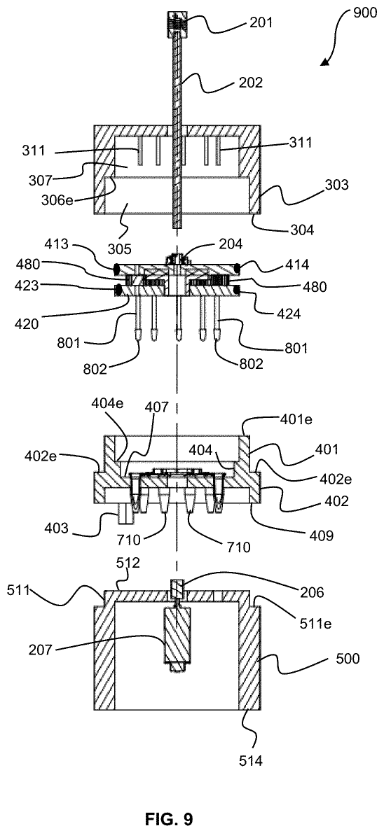

Referring next to FIG. 9, 2D diagram 900 illustrating the complete structure, components, assembling as well as disassembling instructions of first housing unit 300, the second housing unit 400, and the third housing unit 500 of lab sample grinder 100 in accordance with an embodiment of the present invention is illustrated. First, planetary gear system 1000 is assembled as discussed above in FIG. 4. Briefly reviewing, planetary gear system 1000 is placed between first insertion disc 410 and second insertion disc 420 and secured firmly together using spacers 480. From the top side, mounting sleeves 430 are inserted into first array of pestle insertion holes 411. From the bottom side, array of pestles 810 are inserted into second array of pestle holes 421 until pestle rod 801 appears on the surface of first insertion disc 410 as shown in FIG. 4B. Next, array of mortars 711 are inserted one-by-one into array of mortar insertion holes 405 from the top of surface of bottom divider 407. Then, second housing unit 400 is placed on top of third housing unit 500 so that alignment lock key 403 is mated with alignment lock receiver 501, which is accomplished by motion A. Consequently second foot base 409 rests on third collar 511e. The outer edges of both second housing unit 400 and third housing unit 500 are lined up in flush alignment. Next, planetary gear system 1000 sandwiched between first insertion disc 410 and second insertion disc 420 secured together by spacers 480 is placed inside second housing unit 400. Main shaft 200 is inserted through thru hole 302, planetary gear system 1000 via first shaft insertion hole 412, second shaft insertion whole 422, third shaft insertion hole 406, and fourth shaft insertion hole 522. By then, the bottom surface of second insertion disc 420 rests firmly on interior edge 404e so that each header 802 reaches to the bottom of each mortar 711. Next, first housing unit 300 is placed on top of second housing 400 so that first foot base 304 rests on second collar 402e. Internally, first interior collar 306e rests on second top rim 401e, and second foot base 409 rests on third collar 511e. Finally, main shaft 200 is pushed all the down to connect with motor connector 206. After this step, lab sample grinder 100 is lined up as shown in FIG. 1. After the grinding/milling/homogenizing operation, a user can grasp handle 201, unlock tip 205 from motor connector 206, and pull up main shaft 202 all the way by motion B so that the tips of ejecting pins 311 contact and push the bases of pestle rods 801 downward, ejecting array of pestles 810 into array of mortars 711, thus avoiding cross-contamination and aerosolization. Finally, motion C is performed to rest array of mortars 711 containing array of pestles 810; and motion D is performed to loosen array of mortars containing array of pestles 810 from the grips of first array of mortar insertion hole 405 and second array of mortar insertion holes 521.

As seen from FIG. 1 to FIG. 9, the following objectives are achieved:

cross-contamination and aerosolization free using a simple system of geometrical line-up and pestle ejecting pins; and

grinding/milling/homogenzing multiple samples without using more than one electrical motor

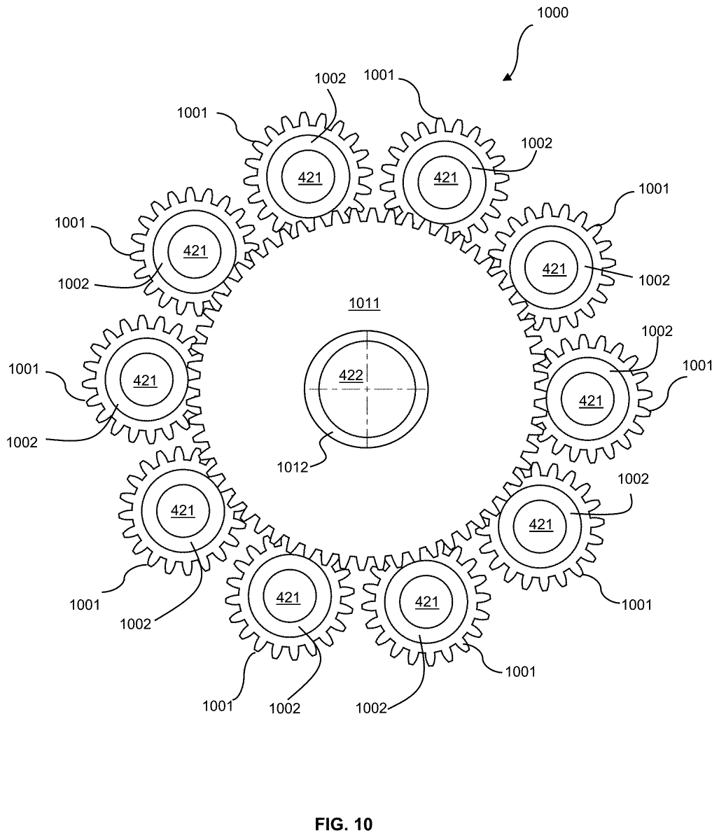

Next referring to FIG. 10, a top-down 2D diagram illustrating the structure of planetary gear system 1000 used in lab sample grinder 100 in accordance with an embodiment of the present invention is illustrated. Planetary gear system 1000 includes driving gear 1011—located at the epicenter—in teeth communication with satellite gears (also driven gears) 1011 around its outer perimeter like a sun in a solar system. Driving gear 1011 has a girth diameter of 60 mm with 60 teeth (Nₚ=60) and a thickness of 5 mm. In many embodiments of the present invention, there are 10 driven gears 1001, each having a girth diameter of 20 mm with 20 tooth (Nₚ=20) and a thickness of 5 mm. Driving gear 1011 has central bearing 1012 which is fit snuggly into second shaft insertion hole 422. Similarly, each driven gear 1001 has a bearing 1002 which is fit snuggly into second array of pestle holes 421. It is estimated that if the angular velocity of motor 207 is 1231 round per minute (V_{c}=1231 rpm), the angular velocity of each driven gear 1001 is 3693 rpm. Vₚ=(N_{c}/Nₚ)V_{c}=1231 rpm×3=3693 rpm.

Using planetary gear system 1000 in many embodiments of lab sample grinder 100 of the present invention achieves the following objectives:

(1) Energy efficient: using one motor to grind/mill/homogenize 10 pestle and mortar samples; and

(2) The grinding angular velocities are amplified without using complicated and expensive electrical motors;

(3) Simple in design and cost effective because the present invention does not use many motors in a complex velocity amplification scheme.

Now referring to FIG. 11, a schematic diagram 1100 representing an electrical system and controls of controller unit 900 in accordance with an exemplary embodiment of the present invention is illustrated. Controller unit 900 includes a central processing unit (CPU) 1110, display timing, light, & emitting diodes (LEDs) controllers 1120, a power supply 1130, an ON/OFF switch 1140, a feedback system 1150, a motor 1160, memory devices 1180, and an input/output communication unit 1190, all connected together by electrical connectors 1199.

In various embodiments of the present invention, a push ON/OFF button 901 is used to turn on or turn off lab sample grinder 100. An ON/OFF control unit 1140, connected to ON/OFF button, is an electrical switch that either connects or disconnects power supplies and voltage regulators 1130 with other components in controller unit 900. Electrical connector 903 uses either electrical power from a wall outlet (not shown) or batteries. In some other embodiments, electrical connector 903 is a typical male-female IEC 320 connectors. In some other embodiments, electrical connector 903 is male DC power jack plugs of various sizes from 0.6 mm to 2.1 mm. Yet in some embodiments, electrical connector 903 is a Universal Serial Bus (USB).

Continuing with FIG. 11, CPU 1110 controls every operating aspects of display timing, light, & emitting diodes (LEDs) controllers 1120, a power supply 1130, an ON/OFF switch 1140, a feedback system 1150, a motor 1160, memory devices 1180, and an input/output communication unit 1190. CPU 1110 is also programmed to communicate with external sources 921 such as smart phones, laptops, desktop computers, personal digital assistance (PDA), and tablets via a communication channel 1198. Past and present data and instructions received from external sources 921 are stored in memories 1180. These data and instructions include time setting and velocity settings, warnings, status, etc. Time and velocity settings can also be accomplished manually via time setting button 905 and velocity setting button 902 respectively. Angular velocity display in rpm is observed through digital display 906. The remained time is observed at display unit 904. It will be appreciated that communication channel 1198 may include, but not limited to, short range wireless communication channels, mid-range wireless communication channels, and long range wireless communication channels. Wireless short range communication channels include ZigBee™/IEEE 802.15.4, Bluetooth™, Z-wave, NFC, Wi-fi/802.11, cellular (e.g., GSM, GPRS, WCDMA, HSPA, and LTE, etc.), IEEE 802.15.4, IEEE 802.22, ISA100a, wireless USB, and Infrared (IR), etc.. Medium range wireless communication channels in this embodiment of communication link include Wi-fi and Hotspot. Long range wireless communication channels include UHF/VHF radio frequencies.

Continuing with FIG. 11, feedback system and sensors 1150 receive operating information from the above-listed components and inform CPU 1110. In many embodiments of the present invention, sensors including temperature, vibration, weight overloading, and voltage or current overloading are used. In a non-limiting examples of the operations of feedback system and sensors 1150 include: when controller unit 900 is overheated, CPU 1110 turns on the warning LED 907. As such, users may stop the grinding/milling/homogenizing operations. Motor 1160 is a speed varying rotor or any type of motor that can vary the angular velocity so that different samples 715 can be grind, milled, or homogenized, depending on each application.

It will be appreciated that electrical connectors 1199 may be electrical wires etched on a printed circuit board (PCB) where central processing unit (CPU) 1110, display timing, light, & emitting diodes (LEDs) controllers 1120, power supply 1130, ON/OFF switch 1140, feedback system 1150, a motor 1160, memory devices 1180, and input/output communication unit 1190 are mounted.

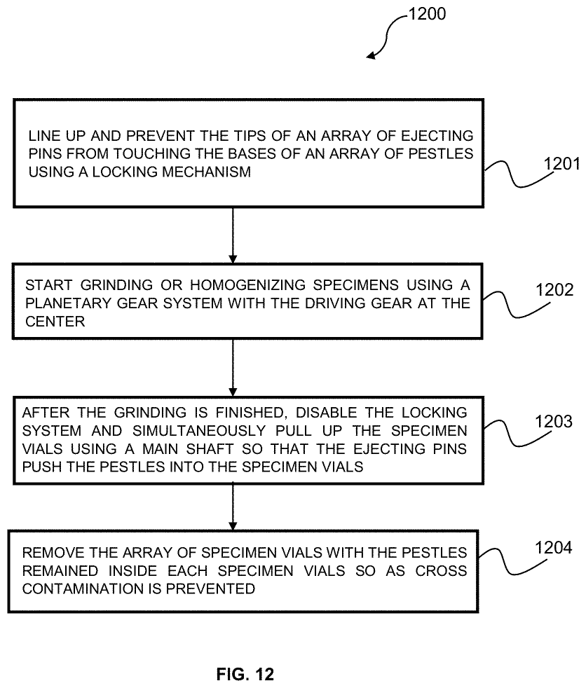

Finally, referring to FIG. 12, a method 1200 of grinding/milling/homogenizing a laboratory sample to achieve efficiency and without cross-contamination in accordance with an exemplary embodiment of the present invention is illustrated. In many aspects of the present invention, method 1200 is performed with lab sample grinder 100 described above. Any devices or apparatuses that employ the steps described below is also within the scope of method 100 of the present invention.

At step 1201, laboratory samples contained in an array of mortars are lined up with an array of pestles ejecting pins using a locking mechanism. Step 1201 is realized by alignment lock key 403, alignment lock receiver 501, array of pestle ejecting pins 311, array of vials 710 inserted in first insertion disc 410 and second insertion disc 420, which is performed by motion A.

Next, at step 1202, the multiple lab samples are milled, homogenized, or ground simultaneously using a planetary gear system. In many aspects of the present invention, step 1202 is realized by planetary gear system 1000 as described in FIG. 10 and motor 207 with controller unit 900 as described in FIG. 11.

At step 1203, after the operation, array of pestles is forced to remain inside array of mortars using the array of pestle ejecting pins. Step 1203 is realized by pulling main shaft 202 all the way up until the tips of array of pestles 311 pushed against the bases of array of pestles 810 until the array of pestles are disconnected from mounting sleeves 430 and fallen into array of mortars 711.

Finally at step 1204, after the operation, laboratory samples are removed with pestles remained inside mortars so that cross contamination between samples. After high speed operations including grinding, milling, homogenizing, etc., if the array of pestles 810 are remained connected to planetary gear system 1000 and mounting sleeves 430, the deaccelerating velocity of motor 207 can definitely causes droplets or debris of samples to spray into adjacent and other mortars, causing contamination. In many aspects of the present invention, step 1204 is realized by pulling up main shaft 202 as described by motion B until array of ejecting pins 311 meet and push array of pestles 810 to fall into array of mortars 711. Next, motions C and D are performed to remove array of mortars 711 from second housing unit 400.

The foregoing description details certain embodiments of the invention. It will be appreciated by a person of ordinary skills in the art that connections between various components described herewith may be by any suitable means such as nails, screws, bolts, connectors, pins, staples, dowels and the like. It also will be appreciated, however, that no matter how detailed the foregoing appears in text, the invention can be practiced in many ways. As is also stated above, it should be noted that the use of particular terminology when describing certain features or aspects of the invention should not be taken to imply that the terminology is being re-defined herein to be restricted to including any specific characteristics of the features or aspects of the invention with which that terminology is associated. The scope of the invention should therefore be construed in accordance with the appended claims and any equivalents thereof.

Aspects of the present invention are described above with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, element components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

While the preferred embodiment to the invention had been described, it will be understood that those skilled in the art, both now and in the future, may make various improvements and enhancements which fall within the scope of the claims which follow. These claims should be construed to maintain the proper protection for the invention first described.

### DESCRIPTION OF NUMERALS

100 laboratory sample grinding/milling/homogenizing device

200 main shaft

202 axle

204 squeeze disc lock

205 axle tip

206 motor connector

207 motor

300 first housing unit

301 top side of first housing unit

302 thru hole

303 lateral side of first housing unit

304 first foot base

305 first bottom interior segment

306e first interior collar

307 first top interior segment

311 array of pestle ejecting pins

313-314 first pair of position locking screws

323-324 second pair of position locking screws

400 second housing unit

401 second top segment

401e second top rim

402 second base segment

403 alignment lock key

404 second interior segment

404e interior edge

405 first array of mortar insertion holes

406 third shaft insertion hole

407 bottom divider

411 first array of pestle insertion holes

412 second shaft insertion hole

413-414 first pair of screw holes

421 second array of pestle insertion holes

422 third shaft insertion hole

423-424 second pair of screw holes

430 mounting sleeves

431 tubular body

432 flange

480 spacers

433-434 third pair of position locking screws

453-454 third pair of screw holes

500 third housing unit

501 alignment lock receiver

502 post-op unlock receiver

510 Third top segment

511 third top segment

511e third collar

512 third top surface

514 third foot base

521 second array of mortar insertion holes

522 fourth shaft insertion hole

710 array of vials

711 mortars

712 hinged lid

713 seal cap

714 solvent

715 sample

810 array of pestles

801 pestle rod

802 header

900 controller unit

901 ON/OFF button

902 speed dial

903 electrical connector

904 display unit

905 operation time setting unit

906 digital running time display unit

907 warning LED

921 external devices

1000 planetary gear system

1001 driven gears

1002 bearings

1011 driving gear

1012 central bearing

1100 Electrical components of the lab sample grinder

1110 CPU

1120 display units & LED controllers

1130 power supplies and regulators

1140 ON/OFF control unit

1150 feedback systems and sensors

1160 speed varying motor

1180 memories

1190 I/O communication unit

1198 External communication channels

1199 Electrical conductors

What is claimed is:

1. A device, comprising:
a controller unit having a motor and a central computing unit (CPU) for varying and controlling the speed of said motor;
a third housing unit, mechanically coupled to said controller base, comprising a lock receiver and an unlock receiver;
a second housing unit, removably laid on top of said third housing unit and configured to contain an array of pestles coupled to a planetary gear system operated by said motor, having a lock key designed to mate with said lock receiver and said unlock receiver; and
a first housing unit, removably laid on top of said second housing unit, having an array of ejecting pins, wherein each of said ejecting pins has a first end fixedly connected to an interior ceiling of said first housing unit and a second end points vertically downward; wherein said array of pestles and said array of ejecting pins are arranged so that when said lock key is mated with said lock receiver said array of ejecting pins is lined up with said array of pestles.

2. The device of claim 1 further comprises a main shaft, removably connected to said motor and said array of pestles, configured to actuate the removal of said array of pestles from an array of mortars using said array of pestle ejecting pins.

3. The device of claim 2 wherein said main shaft further comprises:
a first end removably connected to said motor; and
a second end protruding out of said first housing unit, wherein said main shaft is removably coupled to said array of pestles and said array of mortars.

4. The device of claim 1 wherein said controller unit further comprises a timing setting unit for setting the operation duration of said motor.

5. The device of claim 4 wherein said controller unit further comprises a speed setting unit for setting a speed of said motor.

6. The device of claim 5 wherein said controller unit further comprises a display unit for observing said speed and said operation duration of said motor.

7. The device of claim 1 wherein said third housing unit further comprises a cylindrical top segment stacked directly on a cylindrical bottom segment wherein a pith diameter of said cylindrical top segment is less than a pith diameter of said cylindrical bottom segment.

8. The device of claim 1 wherein said lock receiver and said unlock receiver are female slots cut in at the edge between said cylindrical top segment and said cylindrical bottom segment.

9. The device of claim 1 wherein said third housing unit further comprises a motor connector having a first end connected to said motor and a second end removably connected to said main shaft.

10. The device of claim 1 wherein said second housing unit further comprises a second cylindrical top segment laid on top a second cylindrical bottom segment whose pith diameter is greater than a pith diameter of said second cylindrical top segment, wherein said lock key is attached to a bottom side of said second cylindrical bottom segment.

11. The device of claim 10 wherein said second housing unit further comprises:
a first insertion disc having a first array of pestle holes arranged in a circular formation wherein center-to-center distances between any adjacent said first pestle holes equal to those of said array of pestle ejecting pins; and
a second insertion disc having a second array of pestle holes arranged in a circular formation wherein center-to-center distances between any adjacent said second pestle holes equal to those of said array of pestle ejecting pins and of said first array of pestle holes.

12. The device of claim 11 wherein said lock key is attached to a bottom said of said second cylindrical bottom segment and projecting vertically downward, wherein said lock key has a length equals to that of said lock receiver and greater than that of said unlock receiver.

13. The device of claim 12 wherein said planetary gear system further comprises:
a driving gear located at a center; and
a plurality of driven gears in gear communication and arranged around an outer perimeter of said driving gear.

14. A method of grinding a multiple laboratory samples without cross-contamination, comprising:
(a) lining up an array of mortars containing said laboratory samples with an array of pestle ejecting pins so that an array of pestles are pressed down to fall into said array of mortars by said array of pestle ejecting pins;
(b) maintaining said array of pestles, said array of mortars, and said array of pestle ejecting pins lined up using a pair of male lock key and female lock key; and
(c) starting grinding a plurality of samples using a single motor and a planetary gear system.

15. The method of claim 14 further comprising:
(d) unlocking said planetary gear system from said motor using a main shaft.

16. The method of claim 15 further comprising:
(e) after said grinding of said step (c) is completed, pulling said array of pestles vertically up to contact with said plurality of said pestle ejecting pins until each pestle of said array of pestles is fallen inside each mortar of said array of mortar.

17. The method of claim 16 further comprising:
(f) removing said array of mortars containing said array of pestles therewithin by disconnecting said lock key from said lock receiver;
(g) rotating said of mortars containing said array of pestles in a clockwise direction; and
(h) connecting said lock key with said unlock receiver.

18. A method of manufacturing an efficient and cross-contamination free laboratory sample grinding device, comprising:
(a) preparing ejecting means for ejecting an array of pestles into an array of mortars;
(b) calculating distances between said pestles in said array of pestles, said mortars in said array of mortars, and said means of ejecting means; and
(c) preparing a locking means so that when in lock said array of pestles, said array of mortars, and said ejecting means are lined up.

19. The method of claim 18 further comprising:
(d) preparing means for grinding multiple samples using only one motor; and
(e) preparing releasable means for coupling said array of pestles, said array of mortars, said motor, and said array of grinding means.

20. The method of claim 19 further comprising:
(f) said grinding means is a planetary gear system comprising a driving gear located at a center and a plurality of driven gears in teeth communication and arranged around a perimeter of said driver gear;
(g) calculating a multiplier factor that increases angular velocities of said driven gears from that of said driver gear; and
(h) connecting said driver gear to said motor.
